(19) United States
(12) Patent Application Publication
(10) Pub. No.: US 2014/0302472 A1
(43) Pub. Date: Oct. 9, 2014

(54) LAMAZE BREATHING COACH

(71) Applicant: XEROX BUSINESS SERVICES, LLC, Dallas, TX (US)

(72) Inventor: Denise L. Fletcher, Simsbury, CT (US)

(73) Assignee: XEROX BUSINESS SERVICES, LLC, Dallas, TX (US)

(21) Appl. No.: 13/858,999

(22) Filed: Apr. 9, 2013

(51) Int. Cl. G09B 19/00

(52) U.S. Cl. CPC G09B 19/00
USPC 434/262

(57) ABSTRACT

A system for coaching breathing techniques includes a processor and storage device. An input receiver connected to the processor receives selection of a selected breathing technique. When executed, the processor causes a presentation in a first portion of the display device representing a desired breathing pattern based on the selected breathing technique. The processor monitors breathing sounds from a microphone and causes a presentation in a second portion of the display device representing an actual breathing pattern of a user. The processor correlates the actual breathing pattern with the desired breathing pattern based on the selected breathing technique and provides directions to the user to inhale and exhale according to the selected breathing technique. An image acquisition device acquires image data of the user. The processor correlates the image data of the user with predetermined relaxation images and provides directions to the user to establish a relaxing posture.

### BACKGROUND

Systems and methods herein generally relate to breathing monitoring devices and, more particularly, to devices that coach a user in matching a selected breathing pattern.

One of the most popular and natural techniques for pain management is controlled breathing. Using deep breathing exercises during pregnancy can help focus an expectant mother's concentration on breathing rather than on the pain, promoting a more pleasant, less painful childbirth process. Achieving proper breathing techniques during labor and delivery can be achieved with preparation and practice.

During pregnancy, expecting mothers and a coach (father, relative, or friend) may attend class(es) to learn the Lamaze or Bradley methods of breathing that can be used during labor. Lamaze breathing is typically taught in a classroom setting as part of childbirth education classes. Lamaze classes help an expectant mother to increase confidence, cope with pain, and learn focused breathing. In a similar fashion, Bradley classes focus on diet and exercise during pregnancy, deep breathing, and training of a coach for labor and delivery.

At the onset of labor, however, it is up to the mother and/or coach to use proper breathing techniques, drawing on what they learned in class.

### SUMMARY

Systems and methods herein disclose a breathing coach application that may be installed on a smart device, such as a smart-phone or tablet computer, which applies the Lamaze or Bradley deep breathing method to help train pregnant women before and during labor. Using such an application allows pregnant women to learn and apply proper Lamaze/Bradley breathing techniques during labor with the aid of a smart-phone or tablet device.

According to a system for coaching breathing techniques, the system comprises a housing containing a processor operatively connected to a storage device. An input receiver is operatively connected to the processor. The input receiver receives selection of a selected breathing technique. A microphone is operatively connected to the processor receiving breathing sounds. An image acquisition device and a display device are operatively connected to the processor. The storage device has program code embodied therewith. The program code is readable and executable by the processor that when executed causes a presentation in a first portion of the display device representing a desired breathing pattern based on the selected breathing technique. The processor monitors the breathing sounds and causes a presentation in a second portion of the display device representing an actual breathing pattern of a user. The processor correlates the actual breathing pattern with the desired breathing pattern based on the selected breathing technique and provides directions to the user to inhale and exhale according to the selected breathing technique. The image acquisition device acquires image data of the user. The processor correlates the image data of the user with predetermined relaxation images and provides directions to the user to establish a relaxing posture.

According to a method herein, breathing sounds of a subject are monitored, using a handheld device having a spirometer system. The handheld device receives selection of a selected breathing technique. A representation of a desired breathing pattern, based on the selected breathing technique, is displayed on a first portion of the handheld device. A representation of an actual breathing pattern of the subject, based on the breathing sounds of the subject, is displayed on a second portion of the handheld device. The breathing sounds of the subject are correlated with the desired breathing pattern based on the selected breathing technique, using the handheld device. The subject is prompted to inhale and exhale according to the selected breathing technique, using the handheld device. An image of the subject is acquired, using the handheld device. The image of the subject is correlated with predetermined relaxation images, using the handheld device. The subject is prompted to establish a relaxing posture, using the handheld device.

According to another method, breathing sounds of a subject are monitored, using a handheld device having a spirometer system. The handheld device receives selection of a selected breathing technique. A representation of a desired breathing pattern, based on the selected breathing technique, is displayed on a first portion of the handheld device. A representation of an actual breathing pattern of the subject, based on the breathing sounds of the subject, is displayed on a second portion of the handheld device. The breathing sounds of the subject are correlated with the desired breathing pattern based on the selected breathing technique, using the handheld device. The subject is prompted to inhale and exhale according to the selected breathing technique, using the handheld device. Tactile feedback is provided, using the handheld device, to prompt the subject to inhale and exhale according to the selected breathing technique. Audio feedback is provided, using the handheld device, to prompt the subject to establish a relaxing posture.

According to another method, selection of a selected breathing technique is received, using a computerized device. A representation of a desired breathing pattern based on the selected breathing technique is displayed on a first portion of a display device, using the computerized device. Breathing sounds of a user using a spirometer system operatively connected to the computerized device are monitored. A representation of an actual breathing pattern of the user based on the breathing sounds from the spirometer system is displayed on a second portion of the display device, using the computerized device. The breathing sounds are correlated with the desired breathing pattern based on the selected breathing technique, using the computerized device. Feedback is provided to the user representative of how closely the actual breathing pattern matches the selected breathing pattern, using the computerized device. At least one of tactile feedback and audio feedback is provided to prompt the user to inhale and exhale at a specific time according to the selected breathing technique, using the computerized device. The user is prompted to establish a relaxing posture, using the computerized device.

These and other features are described in, or are apparent from, the following detailed description.

### BRIEF DESCRIPTION OF THE DRAWINGS

Various examples of the systems and methods are described in detail below, with reference to the attached drawing figures, which are not necessarily drawn to scale and in which:

FIG. 1 is a block diagram of a system according to systems and methods herein;

FIG. 2 is an illustration of a handheld device according to systems and methods herein;

FIG. 3 is an illustration of a handheld device according to systems and methods herein;

FIG. 4 is a flow diagram illustrating methods herein;

FIG. 5 is a flow diagram illustrating methods herein; and

FIG. 6 is a flow diagram illustrating methods herein.

### DETAILED DESCRIPTION

The disclosure will now be described by reference to a breathing coach apparatus that includes a spirometer system and microphone to monitor breathing sounds and patterns. While the disclosure will be described hereinafter in connection with specific devices and methods thereof, it will be understood that limiting the disclosure to such specific devices and methods is not intended. On the contrary, it is intended to cover all alternatives, modifications, and equivalents as may be included within the spirit and scope of the disclosure as defined by the appended claims.

For a general understanding of the features of the disclosure, reference is made to the drawings. In the drawings, like reference numerals have been used throughout to identify identical elements.

Disclosed herein is a breathing coach application for a smart device, such as a smart-phone or tablet, which applies the Lamaze or Bradley deep breathing method to help train pregnant women for use of the breathing techniques before or during labor. Using a spiro smart app in a smart-phone or tablet device that is connected with a spirometer, the breathing coach disclosed herein can monitor the breathing pattern of a pregnant woman and provide coaching and correction to ensure the patient maximizes the breathing technique in order to reduce pain during labor.

Generally, in order to accurately measure breathing, a spirometer is required, which is usually in a doctor's office. However, with development of spirometer applications in smart-phone and tablet devices, it is possible to connect breath coaching with a handheld spirometer. Devices disclosed herein monitor the breathing pattern of a pregnant woman and provide immediate coaching and correction to ensure the patient maximizes the breathing technique in order to reduce pain during labor. Devices disclosed herein also provide remote training and help for pregnant women during labor to reduce/alleviate pain. By enabling a breathing coach including visual signals and application of breath measurement on a smart-phone or tablet device, the pregnant woman can achieve proper breathing techniques prior to delivery and during delivery. According to devices and methods herein, this solution would reach remote areas of the global population where childbirth education may not be available.

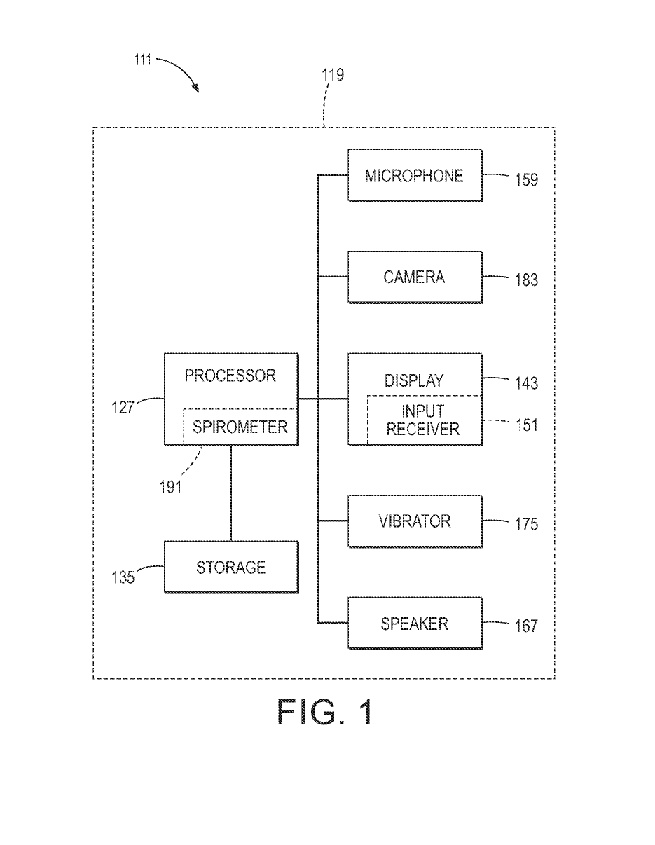

Referring to FIG. 1, a block diagram of a system for coaching breathing techniques, indicated generally as 111, is shown. The system 111 is enclosed in a housing 119. The housing 119 contains a processor 127 operatively connected to a storage device 135. The storage device 135 has program code embodied therewith, which program code is readable and executable by the processor 127, as described in further detail below.

It should be understood that the processor 127 as used herein comprises a computerized device adapted to perform (i.e., programmed to perform, configured to perform, etc.) the below described system operations. According to systems and methods herein, the processor 127 comprises a programmable, self-contained, dedicated mini-computer having a central processor unit (CPU). Computerized devices that include chip-based central processing units (CPU's) are well-known and readily available devices produced by manufacturers such as Dell Computers, Round Rock Tex., USA, and Apple Computer Co., Cupertino Calif., USA. The details of such computerized devices are not discussed herein for purposes of brevity and reader focus.

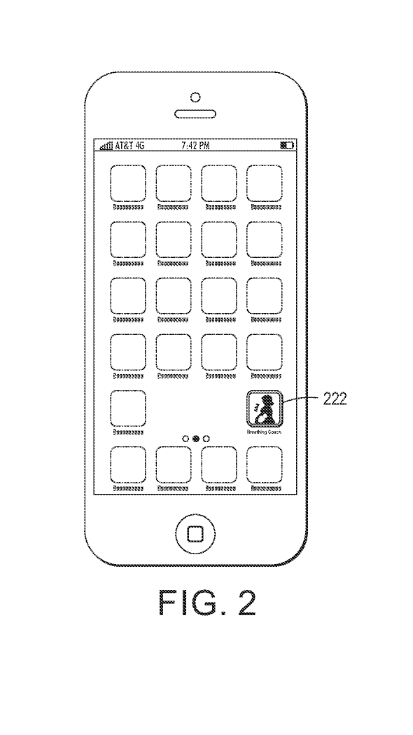

The system 111 includes a display device 143 that can provide a user interface (UI) and can function as the main control interface for the system 111. The display device 143 may be a graphic user interface comprising a touch screen enabled screen, such as shown in FIG. 2, which will be the main go-to point for user interaction with the system 111. The display device 143 should be appropriately sized for a smart-phone or tablet device.

The display device 143 may include an input receiver 151 operatively connected to the processor 127. The input receiver 151 receives selection of a selected breathing technique. For example, referring to FIG. 2, a user may enter a Breathing Coach App by selecting an appropriate icon, such as 222.

The system 111 further includes a microphone 159, to monitor breathing sounds of the user. The microphone 159 is operatively connected to the processor 127. A speaker 167 operatively connected to the processor 127 may provide audio feedback to the user, and a vibrator 175 operatively connected to the processor 127 may provide tactile feedback to the user. A camera 183 or other image acquisition device operatively connected to the processor 127 may also be included in the system 111.

Smart-phone and tablet devices commonly include input/output devices, power supplies, processors, electronic storage memories, wiring, etc., the details of which are omitted herefrom to allow the reader to focus on the salient aspects of the systems and methods described herein.

The following is a non-limiting example of functions a user may be able to perform from the input receiver 151. To being, the user may click on the Breathing Coach icon 222 and select Lamaze or Bradley breathing techniques. The program code when executed by the processor 127 causes a presentation in a first portion of the display device 143 representing a desired breathing pattern based on the selected breathing technique.

Lamaze breathing exercises include baseline breathing, slow breathing, blowing breathing, patterned breathing, and cleansing breathing exercise. The baseline breathing exercise consists of monitoring the user's normal breathing pattern for one minute to determine how many breaths the user normally breathes per minute. The slow breathing exercise consists of inhaling for a count of three, four, or five and exhaling for the same count. The blowing breathing exercise is done by inhaling through the nose and then exhaling by blowing out of the mouth. The patterned breathing exercise is the familiar “hee, hee, hoo” technique that is often associated with Lamaze. This is done by exhaling with two short breaths followed by blowing out the rest of the air through your mouth. Finally, the cleansing breath exercise consists of taking a deep, slow breath in through the nose, then exhaling with a deep, slow breath out of the mouth.

Bradley Breathing: Practice the deep breathing and relaxation methods at home, with the assistance of a support person. Bradley recommends using pillows to support the upper body at a 30-degree angle, to simulate the position of a hospital bed. Bradley Breathing During Labor and Birth:
a. Breathe deeply and slowly during early labor. Relax the jaw and close the eyes. Enlist the support person to observe and coach the user in proper breathing techniques.
b. Continue to use deep abdominal breathing as labor intensifies. Avoid moving or speaking during contractions. Bradley theorized that a relaxed abdomen allows the uterus to contract more efficiently.

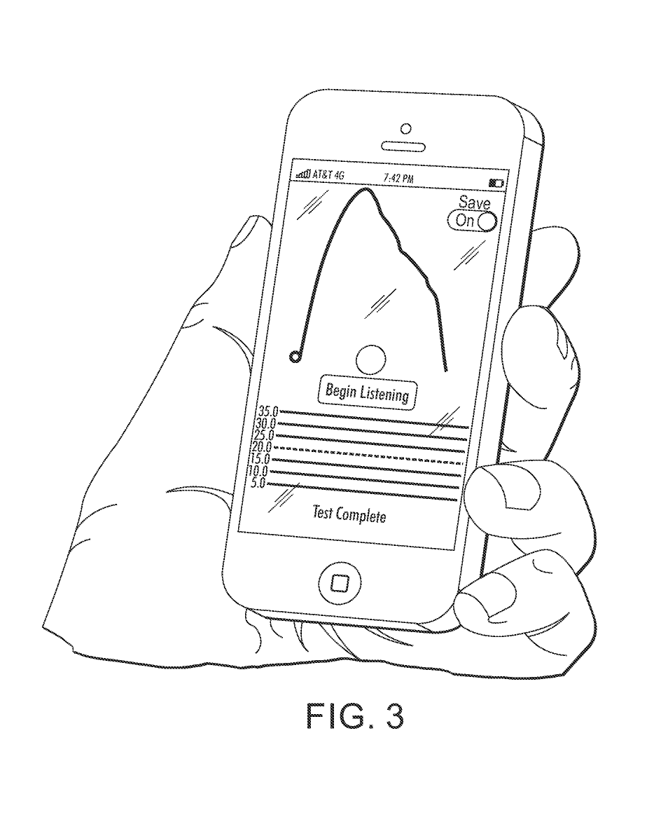

In use, the user or coach may hold the housing 119 at approximately arm's length while the user breathes at the display device 143 of the system 111. The user begins breathing according to the selected pattern. The microphone 159 receives the breathing sounds. The processor 127 monitors the breathing sounds from the microphone 159 and causes a presentation in a second portion of the display device 143 representing an actual breathing pattern of a user, such as shown in FIG. 3.

The display device 143 provides a visual indicator of the selected breathing pattern of the selected breathing technique on a first portion of the display device 143. The display device 143 also provides a visual indicator of the actual breathing pattern of the user on a second portion of the display device 143. For example, such a visual indicator may comprise a picture of a bouncing ball, a moving waveform, or other appropriate image.

The processor 127 may include a built in spirometer 191. The microphone 159 records the sound of inhalation/exhalation and sends the audio data to the processor 127, which correlates the actual breathing pattern with the desired breathing pattern based on the selected breathing technique.

The spirometer 191 measures the user's breathing and returns a response. Measuring the user's breathing may include determining the volume and repetition rate of each breath. Based on the correlation, the processor 127 provides audio instructions to the user using the speaker 167 directing the user to inhale and exhale according to the selected breathing technique. Other audio feedback may include verbal encouragement such as “the breathing is just right” or instruction to correct the breathing according to the method in use. The user repeats the breathing coach for feedback and modulates breathing accordingly.

The speaker 167 provides an audio indicator of the selected breathing pattern of the selected breathing technique. The audio feedback may include voice commands and/or tonal signals. For example, such an audio indicator may comprise a tonal signal to start and/or end the inhaling or exhaling of a breath or tonal signals consisting of varying frequency to assist the user in following the selected breathing pattern.

The spirometer 191 can be used to not only coach deep breathing during labor but also measure the breathing and coach for correction to ensure the patient maximizes the breathing technique to reduce pain during labor. As labor progresses and the frequency and intensity of contractions increases, the user may select different breathing patterns via the input receiver 151.

The system 111 may provide tactile feedback to assist the user in following the selected breathing pattern. The vibrator 175 provides a tactile indicator of the selected breathing pattern of the selected breathing technique. The vibrator 175 may provide a signal to inhale and/or exhale according to the selected breathing pattern. For example, such a tactile indicator may comprise a vibration to signal the start and/or end of inhaling or exhaling a breath.

According to devices and methods herein, the camera 183 or image acquisition device acquires image data of the user. The processor 127 correlates the image data of the user with predetermined relaxation images and provides directions to the user to establish a relaxing posture. For example, if the user is using the Bradley Breathing method, the image acquisition device may determine if the user's body angle is correct. Alternatively, the image acquisition device may detect facial features of the user, such as eyes open or shut, jaw clenched, and other indications of stress. The processor 127 provides directions to the user through the speaker 167 to establish a relaxing posture.

Another feature of the devices and methods herein includes a reporting function, such that when an expectant mother begins labor and activates the system 111 described herein, a message may be sent manually or automatically to an appropriate recipient. For example, the user may select to notify the user's coach and/or doctor. The message may be sent using a Short Message Service (SMS) or email feature of the smart-phone or tablet device. As is known in the art, SMS is a text messaging service component of phone, web, or mobile communication systems, using standardized communications protocols that allow the exchange of short text messages between fixed line or mobile phone devices.

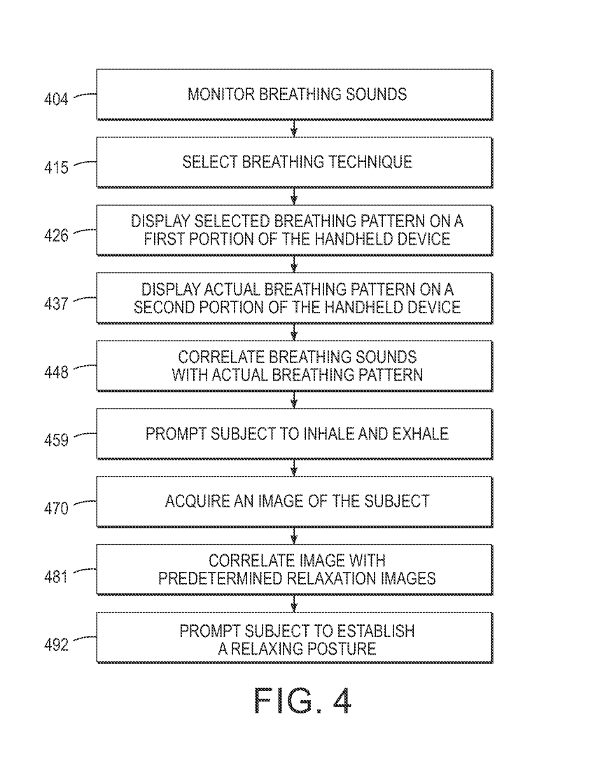

FIG. 4 is a flow diagram illustrating the processing flow of an exemplary method according to systems and methods herein. In item 404, breathing sounds of a subject are monitored using a handheld device having a spirometer system. At 415, the handheld device receives selection of a selected breathing technique. A representation of a desired breathing pattern, based on the selected breathing technique, is displayed on a first portion of the handheld device, at 426. A representation of an actual breathing pattern of the subject, based on the breathing sounds of the subject, is displayed on a second portion of the handheld device, at 437. At 448, the breathing sounds of the subject are correlated with the desired breathing pattern based on the selected breathing technique. At 459, the subject is prompted to inhale and exhale according to the selected breathing technique. An image of the subject is acquired, at 470. The image of the subject is correlated with predetermined relaxation images, at 481. The subject is prompted to establish a relaxing posture, at 492.

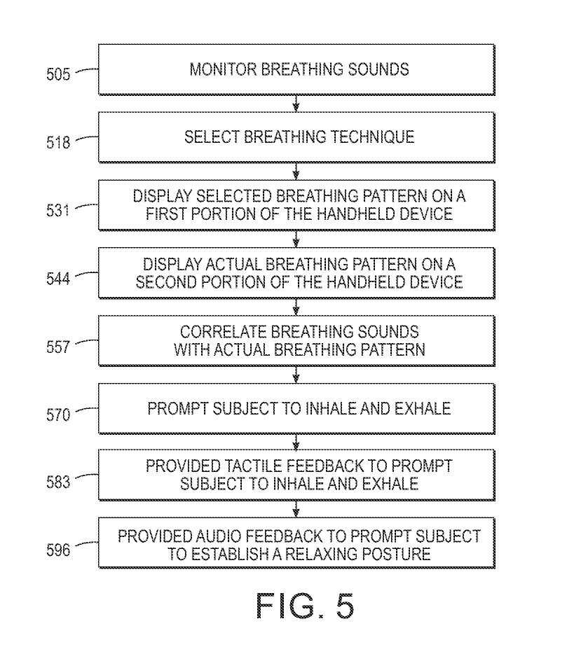

FIG. 5 is a flow diagram illustrating the processing flow of another exemplary method according to systems and methods herein. At 505, breathing sounds of a subject are monitored, using a handheld device having a spirometer system. The handheld device receives selection of a selected breathing technique, at 518. At 531, a representation of a desired breathing pattern, based on the selected breathing technique, is displayed on a first portion of the handheld device. At 544, a representation of an actual breathing pattern of the subject, based on the breathing sounds of the subject, is displayed on a second portion of the handheld device. The breathing sounds of the subject are correlated with the desired breathing pattern based on the selected breathing technique, at 557. The subject is prompted to inhale and exhale according to the selected breathing technique, at 570. Tactile feedback is provided, at 583, to prompt the subject to inhale and exhale according to the selected breathing technique. Audio feedback is provided, at 596, to prompt the subject to establish a relaxing posture.

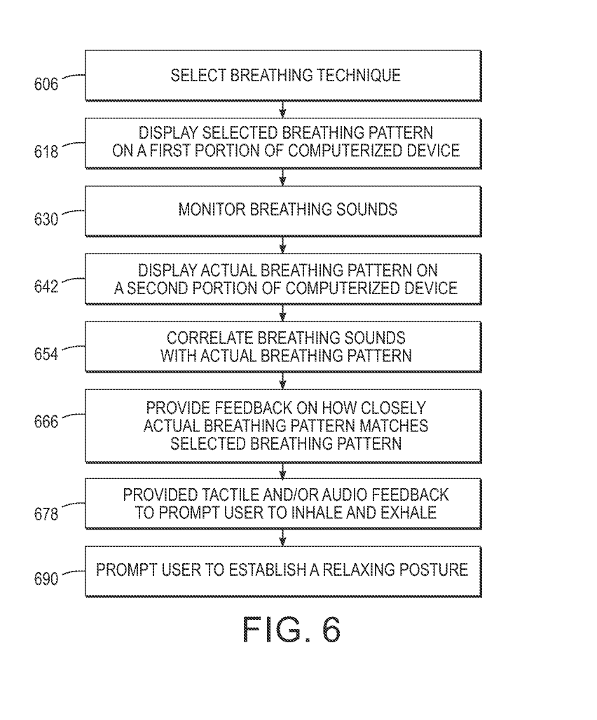

FIG. 6 is a flow diagram illustrating the processing flow of yet another exemplary method according to systems and methods herein. Selection of a selected breathing technique is received, at 606. A representation of a desired breathing pattern based on the selected breathing technique is displayed on a first portion of a display device, at 618. At 630, breathing sounds of a user are monitored using a spirometer system. A representation of an actual breathing pattern of the user based on the breathing sounds from the spirometer system is displayed on a second portion of the display device, at 642. The breathing sounds are correlated with the desired breathing pattern based on the selected breathing technique, at 654. At 666, feedback is provided to the user representative of how closely the actual breathing pattern matches the selected breathing pattern. At 678, at least one of tactile feedback and audio feedback is provided to prompt the user to inhale and exhale at a specific time according to the selected breathing technique. The user is prompted to establish a relaxing posture, at 690.

The terminology used herein is for the purpose of describing particular devices and methods only and is not intended to be limiting of this disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein, are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms ‘automated’ or ‘automatically’ mean that once a process is started (by a machine or a user), one or more machines perform the process without further input from any user.

The corresponding structures, materials, acts, and equivalents of all means or step plus function elements in the claims below are intended to include any structure, material, or act for performing the function in combination with other claimed elements as specifically claimed. The descriptions of the various devices and methods of the present disclosure have been presented for purposes of illustration, but are not intended to be exhaustive or limited to the devices and methods disclosed. Many modifications and variations will be apparent to those of ordinary skill in the art without departing from the scope and spirit of the described devices and methods. The terminology used herein was chosen to best explain the principles of the devices and methods, the practical application or technical improvement over technologies found in the marketplace, or to enable others of ordinary skill in the art to understand the devices and methods disclosed herein.

It will be appreciated that the above-disclosed and other features and functions, or alternatives thereof, may be desirably combined into many other different systems or applications. Those skilled in the art may subsequently make various presently unforeseen or unanticipated alternatives, modifications, variations, or improvements therein, which are also intended to be encompassed by the following claims. Unless specifically defined in a specific claim itself, steps or components of the systems and methods herein should not be implied or imported from any above example as limitations to any particular order, number, position, size, shape, angle, color, temperature, or material.

What is claimed is:

1. A system for coaching breathing techniques, comprising:
a housing containing a processor operatively connected to a storage device;
an input receiver operatively connected to said processor, said input receiver receiving selection of a selected breathing technique;
a microphone operatively connected to said processor, said microphone receiving breathing sounds;
an image acquisition device operatively connected to said processor; and
a display device operatively connected to said processor,
said storage device having program code embodied therewith, said program code being readable and executable by said processor that when executed causes a presentation in a first portion of said display device representing a desired breathing pattern based on said selected breathing technique,
said processor monitoring said breathing sounds and causing a presentation in a second portion of said display device representing an actual breathing pattern of a user,
said processor correlating said actual breathing pattern with said desired breathing pattern based on said selected breathing technique, and providing directions to said user to inhale and exhale according to said selected breathing technique,
said image acquisition device acquiring image data of said user, and
said processor correlating said image data of said user with predetermined relaxation images, and providing directions to said user to establish a relaxing posture.

2. The system according to claim 1, said providing directions to said user to inhale and exhale according to said selected breathing technique comprising prompting said user to take a breath at a specific time using an indicator.

3. The system according to claim 2, said indicator comprising at least one of a visual indicator, an audio indicator, and a tactile indicator.

4. The system according to claim 1, said selected breathing technique comprising one of Lamaze Breathing method comprising a plurality of breathing patterns and Bradley Breathing method comprising a plurality of breathing patterns.

5. The system according to claim 1, further comprising a spirometer operatively connected to said processor.

6. The system according to claim 1, said input receiver comprising a touch screen displaying system status and accepting user input.

7. A method, comprising:
using a handheld device having a spirometer, monitoring breathing sounds of a subject;
receiving, by said handheld device, selection of a selected breathing technique;
displaying on a first portion of said handheld device a representation of a desired breathing pattern based on said selected breathing technique;
displaying on a second portion of said handheld device a representation of an actual breathing pattern of said subject based on said breathing sounds of said subject;
correlating said breathing sounds of said subject with said desired breathing pattern based on said selected breathing technique, using said handheld device;
prompting said subject to inhale and exhale according to said selected breathing technique, using said handheld device;
acquiring an image of said subject, using said handheld device;
correlating said image of said subject with predetermined relaxation images, using said handheld device; and
prompting said subject to establish a relaxing posture, using said handheld device.

8. The method according to claim 7, said prompting said subject to inhale and exhale according to said selected breathing technique comprising prompting said subject to take a breath at a specific time using an indicator.

9. The method according to claim 8, said indicator comprising at least one of a visual indicator, an audio indicator, and a tactile indicator.

10. The method according to claim 7, said selected breathing technique comprising one of Lamaze Breathing method comprising a plurality of breathing patterns and Bradley Breathing method comprising a plurality of breathing patterns.

11. The method according to claim 7, said correlating said breathing sounds of said subject comprising using said spirometer to measure one of a volume and a repetition rate of each breath.

12. The method according to claim 7, said acquiring an image of said subject comprising using a camera feature of said handheld device.

13. A method, comprising:
monitoring breathing sounds of a subject, using a handheld device having a spirometer;
receiving, by said handheld device, selection of a selected breathing technique;
displaying on a first portion of said handheld device a representation of a desired breathing pattern based on said selected breathing technique;
displaying on a second portion of said handheld device a representation of an actual breathing pattern of said subject based on said breathing sounds of said subject;
correlating said breathing sounds of said subject with said desired breathing pattern based on said selected breathing technique, using said handheld device;
providing tactile feedback, using said handheld device, to prompt said subject to inhale and exhale according to said selected breathing technique; and
providing audio feedback, using said handheld device, to prompt said subject to establish a relaxing posture.

14. The method according to claim 13, said prompting said subject to inhale and exhale according to said selected breathing technique comprising prompting said subject to take a breath at a specific time using an indicator.

15. The method according to claim 14, said indicator comprising at least one of a visual indicator, an audio indicator, and a tactile indicator.

16. The method according to claim 13, said selected breathing technique comprising one of Lamaze Breathing method comprising a plurality of breathing patterns and Bradley Breathing method comprising a plurality of breathing patterns.

17. The method according to claim 13, said correlating said breathing sounds of said subject comprising using said spirometer to measure one of a volume and a repetition rate of each breath.

18. The method according to claim 13, said providing tactile feedback comprising using a vibrator feature of said handheld device.

19. A method, comprising:
receiving selection of a selected breathing technique, using a computerized device;
displaying on a first portion of a display device a representation of a desired breathing pattern based on said selected breathing technique, using said computerized device;
monitoring breathing sounds of a user using a spirometer operatively connected to said computerized device;
displaying on a second portion of said display device a representation of an actual breathing pattern of said user based on said breathing sounds from said spirometer, using said computerized device;
correlating said breathing sounds with said desired breathing pattern based on said selected breathing technique, using said computerized device;
providing feedback to said user representative of how closely said actual breathing pattern matches said selected breathing pattern, using said computerized device;
providing at least one of tactile feedback and audio feedback to prompt said user to inhale and exhale at a specific time according to said selected breathing technique, using said computerized device; and prompting said user to establish a relaxing posture, using said computerized device.

20. The method according to claim 19, said prompting said user to inhale and exhale according to said selected breathing technique comprising prompting said user to take a breath at a specific time using an indicator.

21. The method according to claim 20, said indicator comprising at least one of a visual indicator, an audio indicator, and a tactile indicator.

22. The method according to claim 19, said selected breathing technique comprising one of Lamaze Breathing method comprising a plurality of breathing patterns and Bradley Breathing method comprising a plurality of breathing patterns.

23. The method according to claim 19, said correlating said breathing sounds of said user comprising using said spirometer to measure one of a volume and a repetition rate of each breath.

24. The method according to claim 19, further comprising:
sending a message to an appropriate recipient, using said computerized device.
